(19) United States
(12) Patent Application Publication
(10) Pub. No.: US 2010/0132111 A1
(43) Pub. Date: Jun. 3, 2010

(54) KITCHEN SINK WITH A DISH-WASHING APPARATUS, AND WASHING-WATER SPRAY APPARATUS THEREFOR

(76) Inventor: Pil Chan Na, Seoul (KR)

Correspondence Address: MAXON IP LLC, 46175 WESTLAKE DR., SUITE 410, POTOMAC FALLS, VA, 20165, US

(21) Appl. No.: 12/523,024

(22) PCT Filed: Jan. 28, 2008
(86) PCT No.: PCT/KR2008/000507

§ 371 Date: Jul. 13, 2009

(30) Foreign Application Priority Data
Jan. 29, 2007 (KR) 10-2007-0008710
Aug. 10, 2007 (KR) 10-2007-0080707
Jan. 7, 2008 (KR) 10-2008-0001677

(51) Int. Cl. A47K 1/00; B08B 3/00

(52) U.S. Cl. 4/625; 4/654; 134/198

(57) ABSTRACT

A kitchen sink with a dish-washing apparatus incorporated therein, which enables alternative use of a dish-washing function according to necessities, which can be designed simply, inexpensively, and conveniently for use, and which can increase space utilization, comprises a cover for covering an upper portion of a sink basin so as not for water to be splashed outwardly when dishes are arranged on a floor of the sink basin by means of a grill and are washed, a water supply pump for supplying pressurized washing-water, and a washing-water spray means installed at a lower surface of the cover, the floor of the sink basin or a side wall of the sink basin for spraying into the sink basin the washing-water supplied by the water supply pump so as to wash the dishes.

### BACKGROUND OF THE INVENTION

The present invention relates to a kitchen sink with a dish-washing apparatus, and a washing-water spray apparatus therefor, which can be conveniently used by folding, or moving left and right, a cover on the sink installed in the kitchen, which can make various kitchen works possible even under the condition that the dish-washing apparatus is installed in the sink, which structure is simple and which operation is easy. Also, the present invention relates to a kitchen sink with a dish-washing apparatus which can wash dishes by soaking and/or ultrasonic waves when washing dishes and which can sterilize dishes by radiating ultraviolet rays when rinsing dishes. Background Art.

In general, a sink is used for providing a standing kitchen type, which comprises an upwardly opened sink basin at a top portion of a main body of the sink with a predetermined height, the sink basin having a floor provided with a drain outlet. Thus, the sink basin is designed so that washing water can be discharged outward through the drain outlet.

Recently, a lot of dish-washing apparatus engrafted into a kitchen sink are disclosed which can automatically wash dishes, providing convenience for users. However, the conventional dish-washing apparatus, which are mainly proper for European style, are adapted to wash comparatively plain tableware such as dishes, etc., but, in case of Korean tableware having a lot of curved portions, washing power are largely decreased at the spots which injected water does not directly reach, and thus there is a problem in that dry grains of boiled rice or the like are not removed. Therefore, further means for removing dried and sticky grains of boiled rice or dregs are required.

Moreover, in case of using a common detergent for washing dishes, the detergent contained in washing water induces life sewage, and when smooth washing is not achieved, the detergent itself remains on the dishes, thereby having a problem decreasing reliability for the users.

Most of the prior dish-washing apparatus which generate hot washing-water or lather are provided separately from a kitchen sink, but the apparatus have a common problem that its efficiency decreases in space utilization since the apparatus take up comparatively much space.

Accordingly, the present invention is made in order to solve the above problems, and one object of the present invention is to provide a kitchen sink with a dish-washing apparatus incorporated therein, which enables alternative use of a dish-washing function according to necessities, which can be designed simply, inexpensively, and conveniently for use, and which can increase space utilization.

Further, it is another object of the present invention to provide a kitchen sink with a dish-washing apparatus which can wash a lot of dishes at the same time and which can automate water supply and drain, thereby being capable of increasing washing efficiency.

It is still another object of the present invention to provide a kitchen sink with a dish-washing apparatus which can execute dish-washing smoothly by applying ultrasonic waves to the dishes without using any detergent.

It is yet another object of the present invention to provide a washing-water spray apparatus which can be particularly utilized in the foregoing kitchen sink with a dishwashing apparatus and which has a superior washing-water spray function even with a simple structure, thereby being capable of increasing dish-washing efficiency.

To realize one of the above objects of the present invention, a kitchen sink with a dish-washing apparatus is provided in accordance with one embodiment of the present invention, in where at least one sink basin having a drain outlet formed on a floor of the sink basin is installed on an upper portion of a main body in the kitchen sink, said kitchen sink comprising: a cover for covering an upper portion of the sink basin so as not for water to be splashed outwardly when dishes are arranged on the floor of the sink basin by means of a grill and are washed; a water supply pump for supplying pressurized washing-water; and, at least one washing-water spray means installed at at least one of a lower surface of the cover, a floor of the sink basin, or a side wall of the sink basin for spraying into the sink basin the washing-water supplied by the water supply pump so as to wash the dishes.

Furthermore, the present invention is to provide a kitchen sink with a dish-washing apparatus wherein at least one sink basin having a drain outlet formed on a floor of the sink basin is installed on an upper portion of a main body in the kitchen sink, said kitchen sink comprising: a cover for covering an upper portion of the sink basin so as not for water to be splashed outwardly when dishes are arranged on the floor of the sink basin and are washed; at least one ultrasonic generating means which is installed at at least one of a lower surface of the cover, the floor of the sink basin and a side wall of the sink basin, and which radiates ultrasonic waves into the water and to dishes so as to soak and wash dishes after filling water with the sink basin; and, a drain opening/closing means installed at a lower portion of the drain outlet so as to open and close the drain outlet.

Still furthermore, a washing-water spray apparatus for accomplishing another object of the present invention is provided, which is installed at a sink basin or a cover covering an upper portion of the sink basin so as to spray washing-water for dishes, said apparatus comprising: a spray head having spray holes for spraying pressurized washing-water supplied by a water supply pump so as to wash dishes arranged on a floor of the sink basin by means of a grill; a fastening means for rotatably receiving the spray head to install the spray head at a floor of the sink basin, a side wall of the sink basin or the cover; a rotation driving means which is operated by pressurized washing-water supplied by the water supply pump and installed so as to rotate the spray head; an opening/closing member which goes up and down so as to close the spray holes of the spray head for preventing a backward flow from the sink basin during non-washing operation and so as to open the spray holes of the spray head during washing operation; and an up-down means for moving up or down the opening/closing member.

A kitchen sink with a dish-washing apparatus and a washing-water spray apparatus according to the present invention have the following effects.

First, the dish-washing apparatus and the kitchen sink are integrated as one body and can be used as dish-washing function optionally according to the user need, thereby increasing space utilization more than in case of a separate dish-washing apparatus.

Secondly, washing-water is sprayed to every nook and corner of dishes by being sprayed to dishes from an upper side and a lower side, so that dishes are perfectly cleaned, without any foreign substance and even without applying any treatment to dishes arranged in the sink basin.

Thirdly, dish-washing efficiency will be doubled since a series of washing, drying and sterilizing steps can be proceeded in order after a lot of dishes are concurrently arranged in a grill installed in the sink basin.

Fourthly, smooth dish-washing can be obtained without remaining any foreign substance only by applying ultrasonic waves to dishes without using any separate detergent.

Fifthly, washing effect can be maximized by the washing-water spray apparatus according to the present invention, and further another advantage of easy assembly and dismantlement and convenient maintenance is obtained.

### BRIEF DESCRIPTION OF THE DRAWINGS

FIG. 1 is a perspective view for showing one embodiment of a kitchen sink with a dish-washing apparatus according to the present invention, in which a cover case in a cover of a foldable type is moved up on a sink basin.

FIG. 2 is a perspective view for showing a state in which a cover is being drawn out from the cover case in FIG. 1.

FIG. 3 is a perspective view for showing a state in which a cover closes an upper portion of the sink basin in FIG. 1.

FIG. 4 is a schematic front view for showing an inner structure of the kitchen sink with removing a door in FIG. 1.

FIG. 5 is a schematic left side view for showing an inner structure of the kitchen sink with removing a left side wall in FIG. 1.

FIG. 6 shows a section of a cover in FIG. 1, wherein FIG. 6(a) is a cross sectional view of the cover for showing a state in which the sink basin is closed; FIG. 6(b) is a cross sectional view of the cover for showing a state in which the cover is half folded; and FIG. 6(c) is a cross sectional view of the cover for showing a state in which the cover is completely closed.

FIG. 7 is a bottom view of the cover in FIG. 1.

FIG. 8 is a sectional view for showing a detailed structure of a washing-water spray apparatus formed in a drain outlet according to one embodiment,

FIG. 9 is an exploded perspective view for showing the structure of the washing-water spray apparatus of FIG. 8.

FIG. 10 is a cross sectional view of the washing-water spray apparatus of FIG. 8.

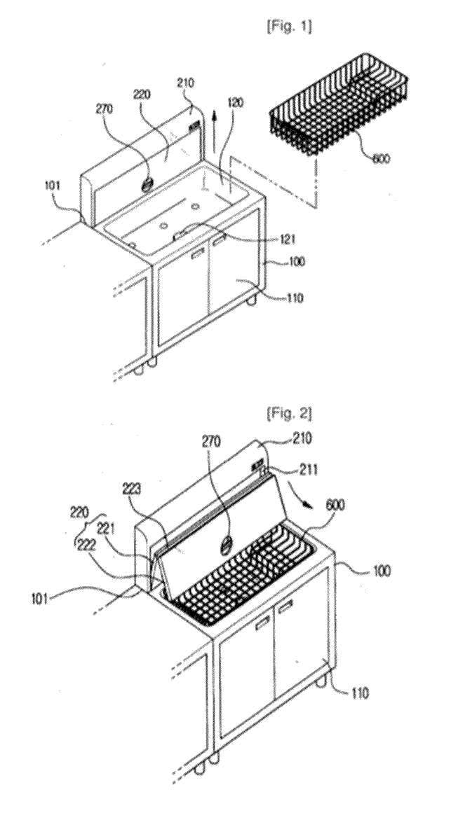

FIG. 1 I(a) and FIG. 1 I(b) are sectional views for showing a dry line and an overflow line connected to the sink basin, respectively.

FIG. 12 shows a particular grill schematically.

FIG. 13 is a plan view for showing a cover structure of a left-right movement type (sliding type) as another embodiment of the kitchen sink with a dish-washing apparatus.

FIG. 14 is a schematical sectional view along line A-A shown in FIG. 13.

FIG. 15 is a schematical sectional view along line B-B shown in FIG. 13.

FIG. 16 is a schematical bottom view of the cover of FIG. 13.

FIG. 17 is a schematical sectional view showing in an installed state a structure of another embodiment of the washing-water spray apparatus.

FIG. 18 is a schematical plan view of the washing-water spray apparatus of FIG. 17.

FIG. 19 is a schematical sectional view for showing a working state of FIG. 17.

FIG. 20 is an exploded sectional view of the washing-water spray apparatus of FIG. 17.

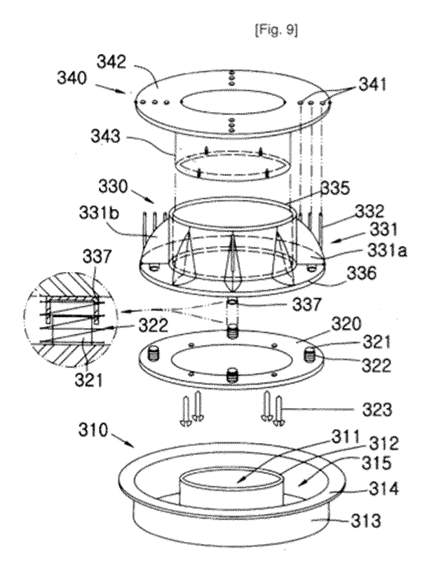

FIG. 21, FIG. 22 and FIG. 23 are respectively a plan view, one longitudinal sectional view and another longitudinal sectional view for schematically showing further modified embodiment of the washing-water spray apparatus shown in the FIG. 8 to FIG. 10.

### DESCRIPTION OF THE INVENTION

Now, several embodiments of a kitchen sink with a dish-washing apparatus and a washing-water spray apparatus according to the present invention will be described in detail with reference to the accompanying drawings.

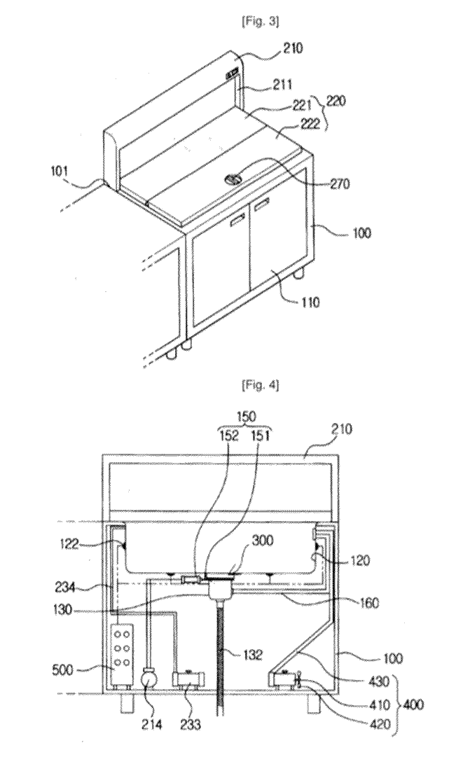

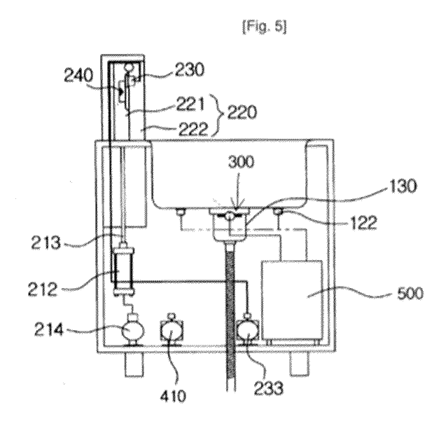

In FIGS. 1 to 3, one embodiment of a kitchen sink with a dish-washing apparatus according to the present invention is illustrated.

In the embodiment, a kitchen sink is provided with a main body 100 having an interior space, and an opening/closing door is commonly installed in a front portion of the main body 100.

A sink basin 120 is installed at an upper portion of the main body 100 in an upward open state, which has a recession of a sufficient depth so as to receive a lot of dishes and a drain outlet 121 formed on a floor of the sink basin 120 so as to drain washing-water. Around the drain outlet 121, a stepped portion 121 a may be formed in a manner such that a washing-water spray apparatus 300 as explained in relation to FIG. 8 can be stably installed as an washing-water spray means.

As shown in FIGS. 4, 5 and 8, the washing-water spray apparatus 300 is installed beneath the drain outlet 121, and a drain trough 130 having an inner space is assembled beneath the washing-water spray apparatus 300 so as to be able to be opened and closed by means of a drain opening/closing means 150, the bottom of the drain trough 130 being connected into a drain hose 132. A collecting net 140 is installed inside the drain trough 130 for filtering food dregs and other materials and a flange 131 is extended outwardly from an upper end of the drain trough 130 so as to be fixedly assembled to the washing-water spray apparatus 300, which is described later.

Furthermore, a grill 600 is stably installed in the sink basin 120 so as to prevent movement of dishes during washing. The grill comprises multiple traverse support members and multiple longitudinal support members which are crossedly assembled with each other at a prescribed angle to receive a lot of dishes. Particularly, as shown in FIG. 12, some traverse support members may be hingedly connected to some longitudinal support members and may be designed to swivel up and down so as to easily place or remove dishes in the grill. Still furthermore, a cover case 210 for receiving a later-mentioned cover 220 and reciprocating together is installed in a rear side of the sink basin 120, the cover case 210 being adapted to be received in the interior space of the main body 100 and to move up on an upside of the main body 100 by the user's operation. That is, the cover case 210 is installed so as to move up and down along an up-down guide groove 101 formed at a rear side of the main body 100.

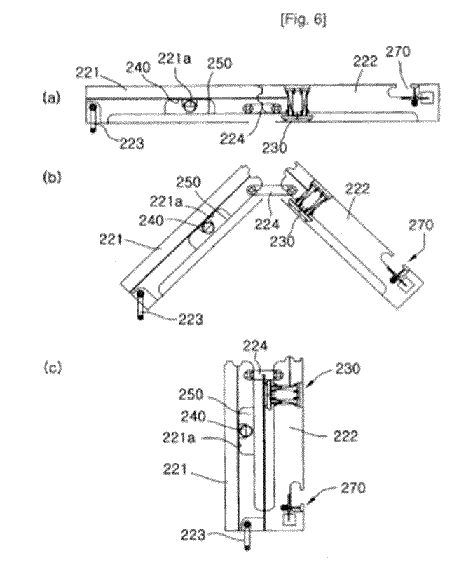

The cover 220 is provided for covering an upper portion of the sink basin 120 so as not for water to be splashed outwardly when dishes are washed. In FIGS. 6(a) to 6(c), the cover 220 is divided so as to be folded and is hingedly connected to a lower end of the cover case 210 so as to rotate by a prescribed angle.

That is, as in FIGS. 6(a) to 6(c), the cover 220 is divided into a first cover 221 and a second cover 222. The first cover 221 is hingedly connected to the cover case 210 by means of links 223 at a rear end of the first cover 221, and the second cover 222 is hingedly connected at the rear end to a front end of the first cover 221 by mean of links 224. Thus, the first cover 221 and the second cover 222 become foldable. A cover receiving recession 211 is preferably provided on a front side of the cover case 210 so as to receive the cover 220 so as not for the cover 220 to be protruded outside, thereby decreasing the whole thickness of the cover case 210.

As not shown, the cover. 220 is divided to be foldable, but may be designed not to move up and down. In this case, without the cover case 210, the first cover 221 may be directly connected at the rear end to the main body 100 or the sink basin 120 by means of links 223.

In FIGS. 4 and 5, an inner structure of the sink basin 120 according to one embodiment of the present invention is illustrated.

In this embodiment, a hydraulic or pneumatic cylinder 212 as a means for reciprocating the cover case 210 is installed at the interior space of the main body 100 together with an oil pump or an air pump 214 for pumping an oil or an air to the hydraulic or pneumatic cylinder 212. That is, the cover case 210 is connected at the bottom to the hydraulic or pneumatic cylinder 212 by means of a connecting rod, the hydraulic or pneumatic cylinder 212 performing up-down movement of the cover case 210 using the pumped oil or air.

In the mean time, one or more ultrasonic generating means 122 are installed at a lower surface of the cover, the floor of the sink basin or a side wall of the sink basin so as to radiate ultrasonic waves into the water and to dishes in the sink basin 120. Commonly, a sealing ring is intervene in a region where the ultrasonic generating means 122 is assembled in order to prevent leakage.

Furthermore, this embodiment further comprises a drying device 400 for removing washing-water from dishes after washing. As in FIG. 4, the drying device 400 is made up of a heater 410 installed within an inner space of the main body 100, and a drying line 430 connecting the heater 100 to the sink basin 120. A fan 420 is desirably provided for strongly supplying wind and heat from the heater 410 to the sink basin 120. Thus, the washed dishes are dried by wind and heat communicated with the sink basin 120 from the heater 410. Dishes may be dried only by wind without the heater 410.

In addition, an ultraviolet lamp 240 is desirably installed on a lower surface of the cover 220 so as to sterilize dried dishes or food dregs by ultraviolet rays. In this case, a lamp mounting groove 221a is formed in a recess shape so as for the ultraviolet lamp 240 to be inserted thereinto, and a transmission plate 250 of a quartz material is installed at the lamp mounting groove 221a so as to allow ultraviolet transmission. Thus, dishes can be sterilized by ultraviolet rays passing through the transmission plate 250 of a quartz material. It is desirable to provide a damping pad for maintaining seal and preventing leakage and damage due to friction in a zone where the cover 220 and the transmission plate 250 are assembled.

Meanwhile, washing, draining, sterilizing, drying etc., in a kitchen sink with a dishwashing apparatus according to the present invention can be controlled by a variety of well-known control modes. Such control operations are performed by a control unit 500 installed in the main body. The control unit 500 is installed in the main body of the kitchen sink for a fine view, and only multiple operation buttons such as an auto-process button, a water supply button, a washing button, a drying button, a sterilizing button, etc., for washing dishes are installed in a front of the kitchen sink. In this case, various operation buttons can be installed on the cover case. Thus, the user may proceed full washing processes by pushing the auto-process button or separately select any process by pushing each button.

The washing-water spray apparatus 300 is installed beneath the drain outlet 121 so as to spray washing-water upward by being assembled in the drain outlet 121. Such a washing-water spray apparatus 300 is mentioned below.

In the meantime, the drain outlet 121 should be able to be opened or closed in case the washing-water spray apparatus 300 is not used, or in case washing-water is stored in the sink basin 120 after washing-water supply is finished through a rotating blade 230 and/or the washing-water spray apparatus 300. Therefore, a drain opening/closing means 150 is installed at a lower portion of the drain outlet 121 so as to open and close the drain outlet 121. One example of the drain opening/closing means 150 comprises an opening/closing member 151 of a schematically plain shape for opening/closing the drain outlet 121, and a solenoid 152 connected to one side of the opening/closing member 151 and operated by the control unit 500.

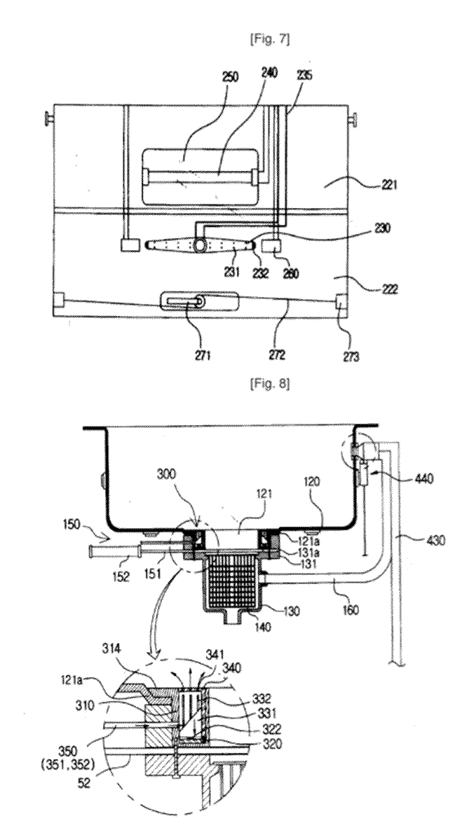

In FIGS. 6(a) to 6(c) and FIG. 7, the cover 220 according to one embodiment of the present invention is illustrated.

The washing-water spray means as one embodiment includes the rotating blade 230 having multiple spray holes, the rotating blade 230 being installed on a lower face of the cover 220 for supplying washing-water into the sink basin 120. The rotating blade 230 is connected to a water supply hose 235 so as to spray washing-water in a state of particles, the water supply hose 235 being connected to a water supply pump so as to supply pressurized washing-water to the rotating blade 230. In this case, it is preferred that the rotating blade 230 be designed to enable ordinary rotation and reverse rotation by a rotation driving means such as a motor, a turbine blade, etc., thereby being capable of spraying washing-water evenly to dishes arranged in the sink basin 120.

Meanwhile, magnetic materials may be attached at opposite ends of the rotating blade 230, and electromagnets 260 may be installed on the lower face so as to enable the rotating blade 230 to stop at a constant position by action of magnetic force when magnetic force is applied to the electromagnets 260.

Further, it is desirable to provide with a locking means 270 for preventing movement of the cover 220 while proceeding the washing process after closing the sink basin 120 with the cover 220. The locking means 270 can be structured variously within the conventional known arts. One example, as shown in FIG. 7, comprises a locking lever 271 installed at a lower center of the second cover 222, and a couple of locking pieces 273 connected to opposite sides of the locking lever 271 with each wire 272. Therefore, in case the locking lever 271 is rotated counterclockwise in a state the cover 220 closes the sink basin 120, the locking pieces 273 are inserted into each locking groove and the cover 220 is firmly fastened. When the locking lever 271 is rotated clockwise after the washing process is finished, the cover 220 can be easily separated from the sink basin 120 and be folded.

One detailed structure of the drain outlet according to one embodiment of the present invention is illustrated in FIG. 8.

As mentioned above, it is preferred that the washing-water spray apparatus be provided for spraying washing-water even from the floor and/or the side wall of the sink basin together with the rotating blade 230 for spraying washing-water from an upper side in order to obtain superior dish washing effect.

That is, in FIG. 8, the washing-water spray apparatus 300 of a cylinder type is further disposed around the drain outlet 121 of the sink basin 120 besides the rotating blade 230 disposed on the lower face of the cover 220. Thus, washing-water can be sprayed concurrently or alternately from the upper and lower directions through the rotating blade 230 and the washing-water spray apparatus 300, thereby obtaining stronger washing operation.

Therefore, even concave dishes or portions of dishes the user can not reach can be cleanly washed. In this case, it is preferable to provide with a water pressure control means for automatically controlling outflow of washing-water according to strength of water pressure or for preventing overload.

Such a washing-water spray apparatus 300, as shown in FIGS. 8 to 10, is installed at a peripheral lower side of the drain outlet 121 and an upper side of the drain trough 130, and provided with a housing 310 as a fastening means and a spray head 340 having one or more spray holes 341. The washing-water spray apparatus 300 further comprises a rotation-elevation means 330 having an outward projection portion 331, which has one or more opening/closing pins 332 formed as the opening/closing member and corresponding to the spay holes of the spray head 340, and an inclined surface formed on the outward projection portion 331 to serve as a moving-down function of an up-down means of the opening/closing pins 332 and as a rotation driving means of the spray head 340, and a spring 322 serving as a moving-up function of the up-down means. The spray head 340, the rotation-elevation means 330 and the spring 322 are installed so as to be rotated together within the housing 310, and the rotation-elevation means 330 is installed within the housing 310 so as to enable up-down movement against the spray head 340. Furthermore, a support plate 320 may be provided so as to support the spring 322 and be rotated together smoothly.

In detail, the housing 310 comprises a drain opening 311, an inner wall 312, an outer wall 313 and a flange 314. In a circumferential space 315 formed between the inner wall 312 and the outer wall 313, the spray head 340 and the support plate 320 are rotatably installed, and the rotation-elevation means 330 and the spring 322 are installed between the spray head 340 and the support plate 320 so as to enable up-down movement thereof.

That is, the drain opening 311 is formed in a center of the housing 310 corresponding to an inner diameter of the drain trough 130, and the inner wall 312 is vertically installed in a concentrical circle section centering the drain opening 311, thereby the circumferential space 315 being formed between the inner wall 312 and the outer wall 313. Therefore, the support plate 320 as a rotation plate are rotatably installed on the floor of the circumferential space 315, and multiple connecting protrusions 321 are formed on the supper plate 320 at a constant space, the spring 322 being partially inserted into the connecting protrusions 321

Further, the rotation-elevation means 330 comprises a circumferential inner wall 335 of a ring type which is provided with one or more outward projection portions 331, and a floor 336 on a lower face of which multiple spring guides 337 are formed. One or two inclined surfaces are formed on each of the outward projection portions 331, the inclined surfaces functioning as a moving-down function of an up-down means of the opening/closing pins 332 and as the rotation driving means of the spray head 340 by pressure of washing-water. That is, the inclined surfaces on the outward projection portions 331 function as a means for concurrently achieving both of rotation and moving-down so as to move the rotation-elevation means 330 at the same time with rotating the support plate 320 and the spray head 340 together by using pressure of washing-water. In this embodiment, the inclined surfaces comprise a first inclined surface 331 a and a second inclined surface 331 b which are outwardly and downwardly inclined. The opening/closing pins 332 may be vertically and upwardly formed between the first inclined surface 331a and the second inclined surface 331b so as to open/close the spray holes 341. The rotation-elevation means 330 can be moved up by being elastically and upwardly supported by the spring 322 on the lower face of the floor 336, thereby the opening/closing pins 332 being able to close the spray holes 341. In order to supply washing-water, one or two water supply hoses 350 or 351 and 352 are connected to the housing 310 from the water supply pump.

And, the spray head 340 is combined with the support plate 320 at a lower end of the inner wall 343 by screws 323 with interposing the rotation-elevation means 330 and the spring 322, thereby being disposed rotatably in the circumferential space between the outer wall 313 and the inner wall 312 of the housing 310.

The foregoing opening/closing pins 332 as the opening/closing member move down by washing-water pressure applied to the first and the second inclined surfaces 331a and 331b, and open the spray holes 341, and thus washing-water is sprayed upward through the rotating spray holes 341. Meanwhile, in case washing-water is not supplied, the opening/closing pins 332 move up by the spring 322 which elastically supports the rotation-elevation means 330, and close the spray holes 341, thereby preventing inflow of filth.

In FIGS. 21 to 23, another embodiment of a washing-water spray apparatus modified from the embodiment of FIGS. 8 to 10 is illustrated. In FIGS. 21 to 23, the housing 310 of FIGS. 8 to 10 is separated into an inner housing 710 of a circular section and an outer housing 720 of an oval section, which are combined with each other using the prior arts, but not shown in detail. The outer housing 720 can be stably fastened to the sink basin 120 by means of a flange 721. The inner housing 710 is structured similarly to the housing 310 of the foregoing embodiment in the spray head 340, the rotation-elevation means 330, the spring 322 and the support plate 320 which are rotatably combined together, but becomes easier in maintenance by being structured so as to be detachably combined into the outer housing 720 using the prior arts. Also, since draining passage is formed between the inner housing 710 and the outer housing 720, thereby facilitating draining. In this case, the water supply hose 350 is connected through a contact portion between the inner housing 710 and the outer housing 720.

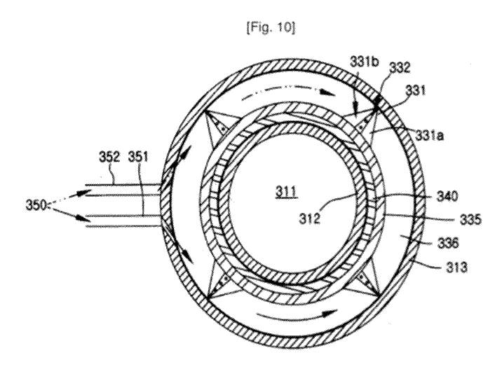

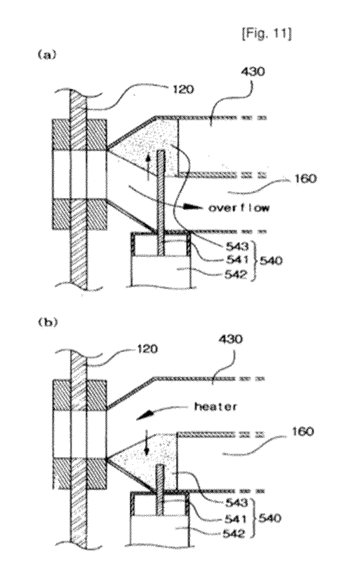

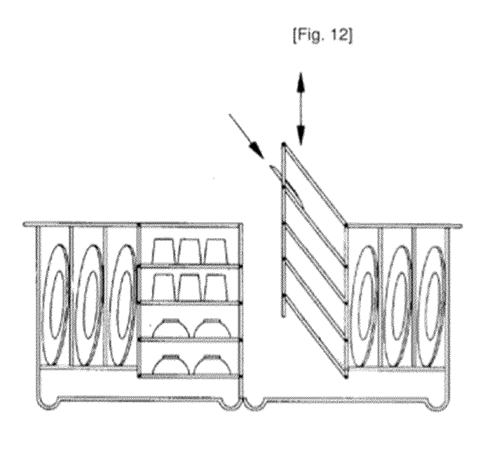

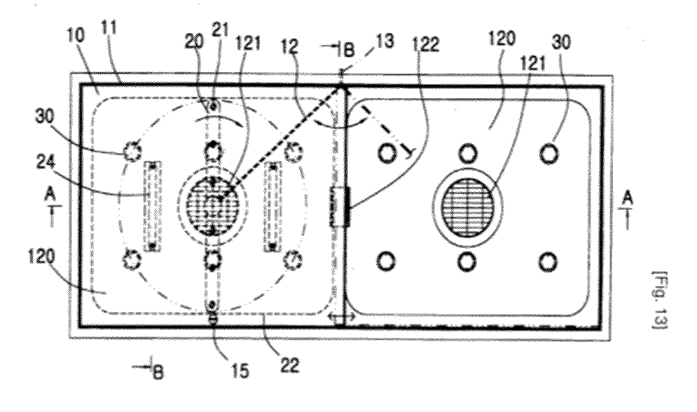

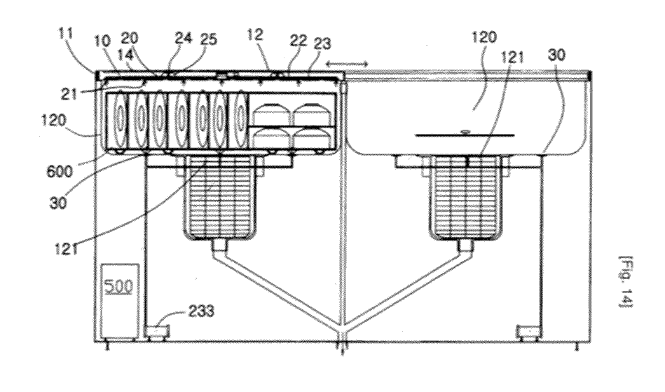

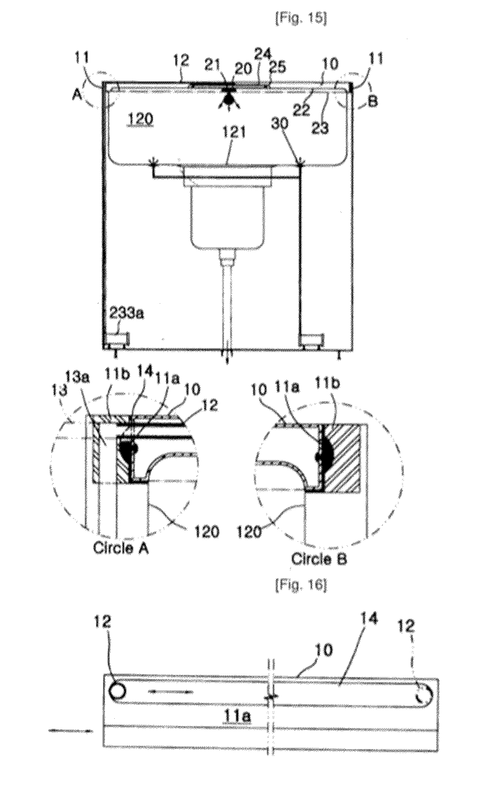

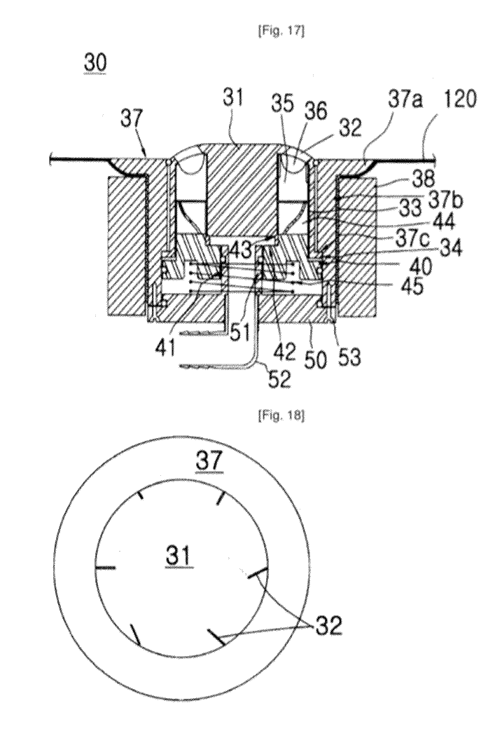

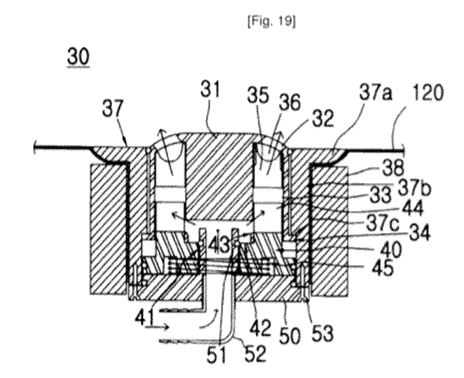

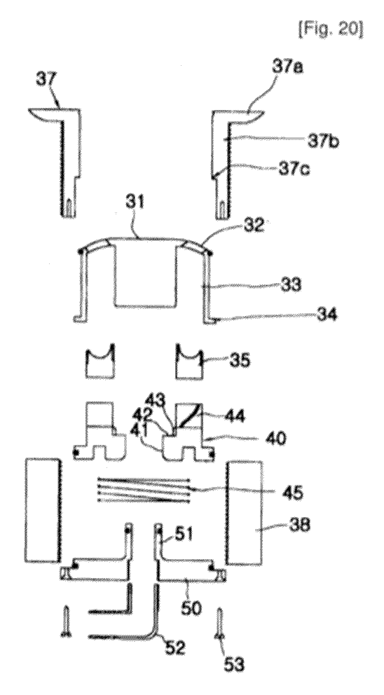

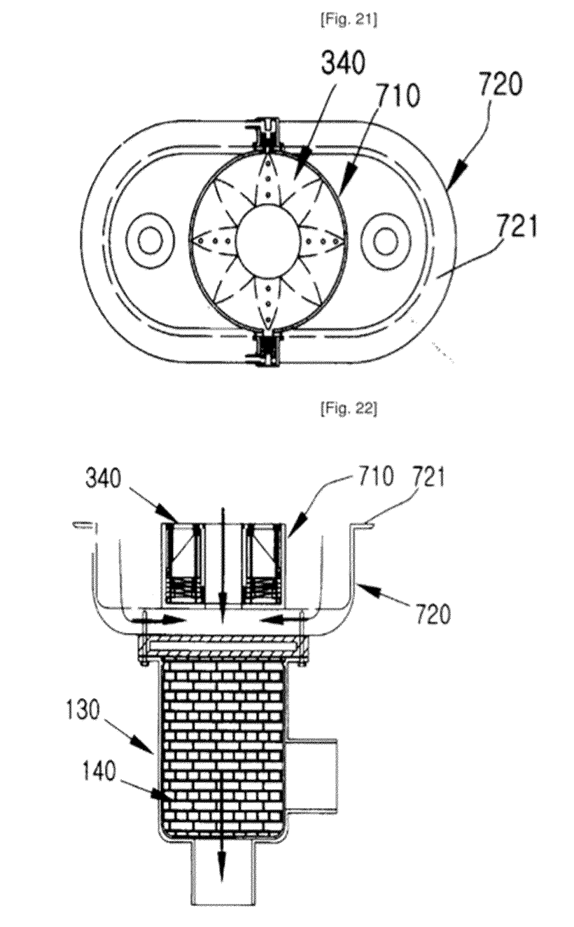

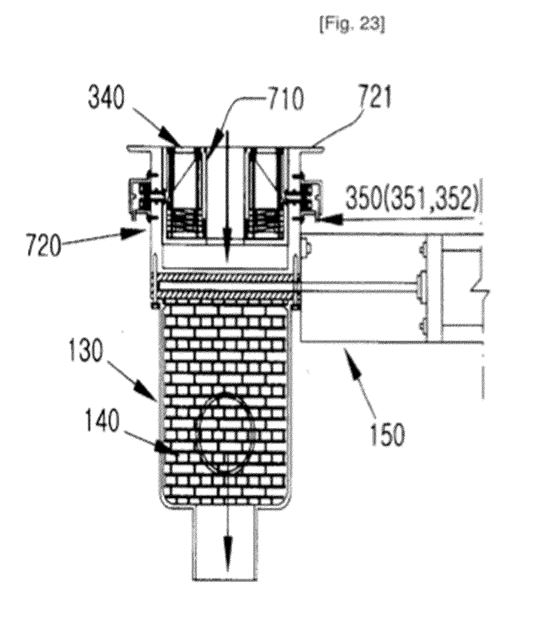

In the meantime, the water supply hose 350 from the water supply pump, as shown in FIG. 10, may be divided into two water supply hoses 351 and 352 by means of a direction control valve, the two water supply hoses 351 and 352 being connected to the housing so as to spray washing-water in opposite directions in the housing 310. The direction control valve can be a solenoid valve operated by a signal from the control unit 500. Thus, in case washing-water is supplied through one water supply hose 351, the washing-water pressure is applied to one inclined surface of the outward projection portions 331, and thus the support plate 320, the rotation-elevation means 330 and the spray head 340 are rotated in one direction, i.e., in a clockwise direction. To the contrary, in case washing-water is supplied through other water supply hose 352 according to the signal of the control unit 500, the washing-water spray apparatus 300 is rotated in other direction, i.e., in a counterclockwise direction. Thus, by repeatedly and alternatingly rotating the washing-water spray apparatus 300 in a clockwise direction and in a counterclockwise direction, washing-water can be effectively sprayed to dishes. Also, only one inclined surface may be provided for any one direction rotation.

In FIGS. 1I(a) and 1I(b), a dry line 430 and an overflow line 160 connected through one common line to the sink basin 120 according to the present invention are shown, respectively.

In FIGS. 1I(a) and 1I(b), the overflow line 160 is connected between one upper end of a wall of the sink basin 120 and one side of the drain trough 130 (see FIG. 4), and therefore superfluous water can be automatically drained from the sink basin 120 through the overflow line 160 and the drain outlet 121.

In case one line of the overflow line 160 and the dry line 430 is open, an airflow opening/closing means 540 is installed so as to close the rest line. As shown in FIGS. 1 I(a) and 1 I(b), the airflow opening/closing means 540 may be installed at a constant angle, and comprise an opening/closing member 543 for alternatively opening/closing the dry line 430 or the overflow line 160, and a solenoid or an air cylinder 541 and 542 connected to the opening/closing member 543 so as to move up and down the opening/closing member 543 according to control of the control unit 500.

Now, action of the kitchen sink with a dish-washing apparatus according to one embodiment of the present invention will be described by way of one example of a control mode.

First, the grill 600 is disposed inside the sink basin 120 and dishes for washing are mounted on the grill 600 (or, the grill 600 could be disposed inside the sink basin 120 after dishes are mounted onto the grill 600).

Then, when an operation button arranged on the cover case 210 is pushed, the cover case 210 is moved up. When the cover case 210 is moved up completely, the user draws the cover 220 from the cover case 210 and closes the upper face of the sink basin 120 with the drawn cover 220. At this time, if the user rotates the locking lever 271, the cover 220 is locked by means of the locking pieces 273. If the locking lever 271 is unfastened, the locking pieces 273 is released from the locking grooves.

Thereafter, if the user pushes a water supply button on the cover case 210, pressurized washing-water is sprayed to dishes through the rotating blade 230 connected to the water supply hose 235, and dishes are washed as a first washing step(in this case, it is possible to construct the structure of the cover case and the cover so as for the cover case to be moved down by pushing the operation button again for preventing injury of the beauty of the kitchen sink before the first washing step). Thus, after washing dishes, washing-water is drained out of the sink basin 120 through the drain outlet 121.

Next, a second washing step is performed. That is, the drain opening/closing means 150 closes the drain outlet 121 and washing-water is sprayed from the rotating blade 230 and the sink basin 120 is filled with the washing-water. Dishes are soaked in the filled washing-water in the sink basin 120 for a prescribed time, and foreign substances such as food scraps, food dregs etc., become swollen. Then, ultrasonic waves are generated from the ultrasonic generating means 122 for a prescribed time, and the washing-water filled in the sink basin 120 is vibrated, thereby the foreign substances being easily separated from dishes. When this step is finished, the drain opening/closing means 150 is open and the washing-water is drained.

Finally, dish washing work is finished after washing-water is sprayed from the rotating blade 230 and the washing-water spray apparatus 300 for performing dish-rinsing operation.

Thereafter, heat generated in the heater 410 is supplied inside the sink basin 120 through the dry line 430, and moisture is removed from dishes. Then, ultraviolet rays are applied to the dried dishes from the ultraviolet lamp 240 with a prescribed time interval, and sterilize the dried dishes. Meanwhile, when heat and ultraviolet rays generated from the heater 410 and the ultraviolet lamp 240 are supplied, the supplied heat and ultraviolet rays dry and sterilize foreign substances besides dishes. Also, since the food dregs collected in the collecting net 140 are dried by wind and heat and are not dripped from the food dregs when they are removed, it is easier for the user to remove the dried food dregs.

In FIGS. 13 to 16, another embodiment of the kitchen sink with a dish-washing apparatus is shown, which has a cover structure of a left-right movement type(sliding type). FIGS. 14 and 15 are sectional views along lines A-A and B-B of FIG. 13.

In FIGS. 13 to 16, the kitchen sink with a dish-washing apparatus and a left-right movement type cover structure is applied to one having at least one sink basin 120 (two sink basins in the drawings) in which a drain outlet 121 is provided, and basically comprises a cover 10, a washing-water spray means 20, 30 or 30a, a left-right movement guide means 11 for the cover 10, a washing-water supply line 12 connected to the washing-water spray means 20, 30 or 300, and a movement allowance means for allowing movement of a washing-water supply line during movement of the cover 10.

As shown in FIGS. 13 and 14, the cover 10 is installed so as to be able to move at least between an open position for opening an upper portion of the sink basin 120 (wherein an upper portion of another sink basin may be closed) and a closed position for covering an upper portion of the sink basin so as not for water to be splashed outwardly when dishes are arranged on a floor of the sink basin 120 by means of a grill 600. In FIGS. 13 and 14, the cover 10 moves between a pair of sink basins 120, but the present invention is not limited to this embodiment. It is possible for the cover 10 to move between a sink basin 120 and a kitchen sink which is not provided with a sink basin, or among three or more sink basins.

The washing-water spray means 20, 30 or 300 is to spray washing-water and to wash dishes in the sink basin 120. In FIGS. 13 and 14, a rotating blade 20 having multiple spray holes 21 is installed as one of the washing-water spray means, which is not limited to this embodiment, but can be constructed only by spray holes formed on a lower surface of the cover 10, or by a washing-water spray apparatus 30 or 300 (see FIGS. 8 and 17) having multiple spray holes. In case of the rotating blade 20, a recession 22 is formed on the lower surface of the cover 10 so as not to protrude from the lower surface of the cover 10 at least within the scope of rotation of the rotating blade 20 as shown in FIGS. 13 to 15, and thus the rotating blade 20 does not hang on an inner wall of the sink basin 120 when moving left or right. Also, a safety net 23 is preferably installed for safety against the rotating blade 20 as shown FIGS. 14 and 15.

The left-right movement guide means 11 is installed between the cover 10 and the upper surface of the sink basin 120 for guiding left-right movement of the cover 10, and various conventional configurations can be employed as the left-right movement guide means 11. In FIGS. 13 to 15 (particularly in FIG. 15), the left-right movement guide means 11 comprises a protrusion means I Ia and a recess means 1 Ib which are installed in the cover 10 and the sink basin 120 respectively, so as to allow sliding movement concurrently with preventing from leakage. One of the protrusion means I Ia and the recess means 1 Ib is preferably formed of an elastic material such as rubber. Such a slide combination mode can be conveniently constructed for a leakage-prevention structure. In this embodiment, the slide combination mode is shown and explained as one example of the left-right movement guide means 11, which is not limited to that mode. Although it is not shown, it is possible to move the cover 10 on the sink basin 120 using rollers and roller-guide grooves, etc.

The washing-water supply line 12 is connected to the water supply pump 233a (see FIG. 15) so as to supply pressurized washing-water to the washing-water spray means 20, 30 or 300, for which a flexible rubber hose is employed so as to be bent in an arrow direction in FIG. 13 without limiting the present invention. Various well-known configurations can also be employed for the washing-water supply line 12.

Furthermore, the washing-water supply line 12 may be connected to the water supply pump 233a through an outward protruded washing-water supply line connection member 13 of FIG. 13 or a washing-water supply line connection hole 13a of FIG. 15. The washing-water supply line connection hole 13a may be formed passing through the left-right movement guide means 11 as shown in FIG. 15.

FIG. 13 illustrates one construction in which one end of the washing-water supply line 12 within the cover 10 is swivelled against other end of the washing-water supply line 12 for movement of the washing-water supply line 12 following left-right movement of the cover 10. However, said one end of the washing-water supply line 12 may be fixed within the cover 10, and the washing-water supply line connection member 13 or the other end of the washing-water supply line 12 may be swivelled.

The movement allowance means may be a washing-water supply line throughhole 14, which is installed in one of the cover 10 or the sink basin 120 so as to allow movement of one end of the washing-water supply line 12, the washing-water supply line connection member 13 or the other end of the washing-water supply line 12. In FIG. 15, the movement allowance means is the washing-water supply line throughhole 14, but not limited thereto. The washing-water supply line throughhole 14 as one example of the movement allowance means is formed from side to side along a length of a rear face of the cover 10 as shown in FIG. 16, and the washing-water supply line 12 moves between a solid line and a dotted line in FIG. 16 along the washing-water supply line throughhole 14 together with left-right movement of the cover 10.

Furthermore, it is preferable to be provided with a locking means 15, which can press and lock the cover 10 to an upper surface of the sink basin 120 so as to prevent movement and leakage during washing. Various known configurations may be employed for the locking means 15 without any limitation.

An ultraviolet lamp 24 is preferably installed on a lower surface of the cover 10 so as to sterilize dishes by ultraviolet rays. As shown in FIGS. 13 to 15, the ultraviolet lamp 24 is installed at a lamp mounting groove 25 formed on the lower surface of the cover 10.

Still furthermore, the washing-water spray apparatus 30 is preferably installed on a floor of the sink basin 120 besides the rotating blade 20. Although not shown, the washing-water spray apparatus 30 may be installed on the side wall of the sink basin 120. Such washing-water spray means 20, 30 or 300 can be operated in various known mode. For an example, the washing-water spray means 20 and 30 or 300 can be operated alternately up and down. The water supply pump 233 or 233a may be installed separately for an upper and lower washing-water spray means 20 and 30 or 300, as shown in FIGS. 5 and 15, and connected to each washing-water spray means 20, 30 or 300 from one water supply pump through a variously controllable direction control valve.

An unexplained reference numeral “ 160” is an overflow line installed at an upper portion of the side wall of the sink basin 120, “500” is a control unit for controlling the aforementioned elements, and a control panel and various know control modes are omitted for brief explanation or illustration. A dry system using the overflow line and an ultrasonic generating means 122 with the drain opening/closing means for the drain outlet as described in relation to the foregoing embodiments can be employed in this embodiment. The prior known configurations using a detergent supply system may also be employed in the present invention.

Such a kitchen sink with a dish-washing apparatus is provided with the cover 10 installed so as to be able to move from side to side, and thus the sink basin 120 can be opened or closed simply by pushing or sliding the cover 10 from side to side. Also, in this embodiment, wide space is not necessary for installation or operation since there is no hinge motion differently from the foregoing embodiment, and kitchen work can be facilitated in a state wherein the cover 10 is installed.

In FIGS. 17 to 20, another embodiment of the washing-water spray apparatus 30 is shown.

The washing-water spray apparatus 30 basically comprises a spray head 31, a fastening means 37 and 38, a rotation driving means 35 and an opening/closing member 40.

The spray head 31 has multiple spray holes 32 for spraying pressurized washing-water supplied by a water supply pump 233 so as to wash dishes arranged in the sink basin 120 by means of a grill 600, and is installed rotatably within the fastening means 37 and 38. As in FIG. 18, the spray holes 32 may be formed in various angles, various plan arrangements and/or various sectional shapes so as to spray washing-water in various spray forms. Thus, washing-water can be sprayed in every space within the sink basin since washing-water can be sprayed in various spray forms and/or at various angles, and thus washing efficiency even for various dishes is maximized.

As shown in FIGS. 17, 19 and 20, a downward circumferential space 33 is preferably formed in the spray head 31 so as to be able to supply washing-water to the spray holes 32 from the lower portion of the downward circumferential space, and to install a later-described rotation driving means 35 therein. A projection stopper portion 34 is formed at a peripheral end of an outer wall of the downward circumferential space 33.

The fastening means 37 and 38 rotatably receives the spray head 31 and is installed on a side wall or a floor of the sink basin 120, the fastening means 37 and 38 comprising a fixing member 37 and a fastening nut 38 as shown in FIGS. 17 and 19. The fastening means 37 and 38 further comprises a flange 37a installed on a circumferential upper end of a mounting opening of the sink basin 120, and a cylinder portion 37b which is formed in the fixing member 37 downwardly passing through the mounting opening of the sink basin 120 and on the periphery of which a male thread is formed. The fixing member 37 is made up of a projection receiving portion, which hangs the projection stopper portion of the spray head so as not for the spray head to come off upward.

As shown in FIGS. 17 and 19, the fastening nut 38 is engaged with the male thread of the cylinder portion 37b of the fixing member 37, thereby the spray head 31 being capable of being detachably installed around the mounting opening of the sink basin 120. The fastening means 37 and 38 is not limited to such a construction, and detachable installation is convenient for maintenance. However, undetachable installation structure may be employed.

The rotation driving means 35 is installed within the spray head 31 so as to rotate together with the spray head 31 by pressurized washing-water supplied from the water supply pump 233. Although the detailed structure between the rotation driving means 35 and the spray head 31 for rotating together with the spray head 31 is not shown, one of well-known structures such as a spline engagement can be employed.

The opening/closing member 40 is installed so as to close a washing-water supply passage to the spray holes 32 of the spray head 31 for preventing a backward flow from the sink basin 120 during non-washing operation, and so as to open the washing-water supply passage to the spray holes 32 and the rotation driving means 35 within the spray head 31 during washing operation.

The opening/closing member 40 as one example comprises a central throughhole 41 through which to supply washing-water, a pressure working portion 42 extended radially outwardly from an upper end of the central throughhole 41 so as to move down the opening/closing member 40 by operation of washing-water pressure when the washing-water supply passage from the central throughhole 41 to the circumferential space 33 of the spray head 31 is blocked, an opening/closing portion 43 for spacing from, and contacting with, the lower end portion of an inner wall of the circumferential space 33 of the spray head 31 so as to open/close the washing-water supply passage between the central throughhole 41 and the circumferential space 33 of the spray head 31, and a guide portion 44 for changing a flow direction of washing-water so as to effectively rotate the rotation driving means 35 such as a turbine blade, the guide portion 44 being inserted into the circumferential space 33 of the spray head 31. The pressure working portion 42 serves as a moving-down function of the up-down means for the opening/closing member 40.

A spring 45 is further installed between a lower member 50 and the opening/closing member 40 so as to close the opening/closing member 40 opened by the washing-water pressure. That is, the spring 45 serves as a moving-up function of the up-down means for the opening/closing member 40 during non-washing.

The lower member 50 comprises a central cylinder portion 51 to which a washing-water supply line connection 52 is connected and which is fastened to a lower end of the fixing member 37 by screws so as to prevent leakage of washing-water in the lower direction of the opening/closing member 40.

Various known configurations can be employed for the opening/closing member 40 or the lower member 50 without any limitation to the shown embodiment.

A space 36 for dispersing a flow direction of washing-water from the rotation driving means 35 is preferably formed between the spray holes 32 and the rotation driving means 35 so that washing-water is sprayed according to various angles and shapes of the spray holes 32, regardless of an angle of a washing-water flow coming out from the rotation driving means 35.

Although not shown, when the washing-water spray apparatus 30 is installed at a side wall of the sink basin 120, each of an upper portion and a lower portion of the spray head 31 in the drawings faces each of an interior and an exterior of the sink basin 120 in the vertical direction.

According to the configurations described above, the washing-water spray apparatus 30 is simply constructed, has no fear of contamination or blockage by filth, maximizes washing effect by rotation and various configuration of the spray holes 32, and provides easy assembly and dismantlement and convenient maintenance.

1. A kitchen sink with a dish-washing apparatus wherein at least one sink basin having a drain outlet formed on a floor of the sink basin is installed on an upper portion of a main body in the kitchen sink, said kitchen sink comprising: a cover for covering an upper portion of the sink basin so as not for water to be splashed outwardly when dishes are arranged on the floor of the sink basin by means of a grill and are washed; a water supply pump for supplying pressurized washing-water; and, at least one washing-water spray means installed at at least one of a lower surface of the cover, a floor of the sink basin, or a side wall of the sink basin for spraying into the sink basin the washing-water supplied by the water supply pump so as to wash the dishes.

2. A kitchen sink with a dish-washing apparatus as set forth in claim 1 wherein said cover is divided into a first cover and a second cover backward and forward so as to be folded at an open position in which the cover opens the upper portion of the sink basin and so as to be unfolded at a closed position in which the cover closes the upper portion of the sink basin, the first cover being adapted for rotating at a rear end thereof into a vertical position against the sink basin or the main body of the kitchen sink, and the second cover being hingedly connected at a rear end thereof to a front end of the first cover.

3. A kitchen sink with a dish-washing apparatus as set forth in claim 2, further comprising a cover case in which the folded first and second covers are received when said first and second covers are folded, the first cover being rotated at the rear end through the cover case by being connected to the cover case by hinges at the rear end of the first cover, and a means for reciprocating the cover case between an upper portion and a lower inside of the main body of the kitchen sink.

4. A kitchen sink with a dish-washing apparatus as set forth in claim 1, further comprising a left-right movement guide means which is installed between the cover and the sink basin, the left-right movement guide means guiding left-right movement of the cover so as to allow movement of the cover on the upper surface of the sink basin between a closed position in which the cover closes the upper portion of the sink basin, and an open position in which the cover opens the upper portion of the sink basin and may close an upper portion of another sink basin.

5. A kitchen sink with a dish-washing apparatus as set forth in claim 4: wherein the washing-water spray means installed at the lower surface of the cover; and wherein a movement allowance means, such as a washing-water supply line throughhole, is installed in one of the cover or the sink basin so as to allow movement of one end of a washing-water supply line connected to the washing-water spray means relatively against the other end of the washing-water supply line.

6. A kitchen sink with a dish-washing apparatus as set forth in claim 4, wherein the left-right movement guide means comprises a protrusion means and a recess means which are installed in the cover and the sink basin respectively so as to allow sliding movement concurrently with preventing from leakage, one of the protrusion means and the recess means being formed of an elastic material such as rubber.

7. A kitchen sink with a dish-washing apparatus as set forth in claim 2, wherein the washing-water spray means is one of a rotating blade having multiple spray holes and a washing-water spray apparatus having a rotating spray head.

8. A kitchen sink with a dish-washing apparatus wherein at least one sink basin having a drain outlet formed on a floor of the sink basin is installed on an upper portion of a main body in the kitchen sink, said kitchen sink comprising: a cover for covering an upper portion of the sink basin so as not for water to be splashed outwardly when dishes are arranged on the floor of the sink basin and are washed; at least one ultrasonic generating means which is installed at at least one of a lower surface of the cover, the floor of the sink basin and a side wall of the sink basin, and which radiates ultrasonic waves into the water and to dishes so as to soak and wash dishes after filling water with the sink basin; and, a drain opening/closing means installed at a lower portion of the drain outlet so as to open and close the drain outlet.

9. A kitchen sink with a dish-washing apparatus as set forth in claim 1 or 8, further comprising a locking means which can press and lock the cover to an upper surface of the sink basin so as to prevent movement and leakage during washing or soaking.

10. A kitchen sink with a dish-washing apparatus as set forth in claim 1 or claim 8, wherein an ultraviolet lamp is further installed on a lower surface of the cover so as to sterilize dishes by ultraviolet rays.

11. A kitchen sink with a dish-washing apparatus as set forth in claim 1, further comprising a drying device which is made up of: a heater installed within an inner space of the main body of the kitchen sink; a fan for blowing wind and heat from the heater;
and, a drying line through which the wind and heat are blown in the sink basin by the fan so as to dry washed dishes.

12. A kitchen sink with a dish-washing apparatus as set forth in claim 11: wherein an overflow line is provided for draining water overflowing from the sink basin; and wherein an airflow opening/closing means and a common line are further provided so as to selectively connect one of the drying line or the overflow line to the sink basin by means of the airflow opening/closing means.

13. A washing-water spray apparatus which is installed at a sink basin or a cover covering an upper portion of the sink basin so as to spray washing-water for dishes, said apparatus comprising: a spray head having spray holes for spraying pressurized washing-water supplied by a water supply pump so as to wash dishes arranged on a floor of the sink basin by means of a grill; a fastening means for rotatably receiving the spray head to install the spray head at a floor of the sink basin, a side wall of the sink basin or the cover; a rotation driving means which is operated by pressurized washing-water supplied by the water supply pump and installed so as to rotate the spray head; an opening/closing member which goes up and down so as to close the spray holes of the spray head for preventing a backward flow from the sink basin during non-washing operation and so as to open the spray holes of the spray head during washing operation; and, an up-down means for moving up or down the opening/closing member.

14. A washing-water spray apparatus as set forth in claim 13: wherein the spray head comprises an circumferential inner wall; wherein the fastening means is a housing, said housing having a drain opening which is formed at a center of the housing so as to communicate with a drain outlet of the sink basin, an inner wall and an outer wall which are formed around the drain opening and connected together by a floor portion with an upward circumferential space between each other so as for the spray head to be rotatably inserted from an upper portion of the upward circumferential space, and a flange which extends outward from an upper end of the outer wall so as to fix the housing to a periphery of the drain outlet; wherein the rotation driving means, a moving-down function of the up-down means and the opening/closing member are integrated as one body by a rotation-elevation means, one or more outward projection portions being formed on a circumferential inner wall of a ring type, said rotation-elevation means having an inclined surface formed on said one or more outward projection portions so as to execute the moving-down function of the up-down means, and said rotation-elevation means further having one or more opening/closing pins formed as the opening/closing member on the outward projection portions so as to close the spray holes when being moved up; wherein a spring is inserted in the circumferential space of the housing beneath the rotation-elevation means so as to execute a moving-up function of the up-down means; and, wherein a support plate is fastened to a lower end of the circumferential inner wall of the spray head so that the spray head, the rotation-elevation means and the spring may rotate together within the circumferential space of the housing.

15. A washing-water spray apparatus as set forth in claim 14, wherein a drain opening/closing means is installed at a lower portion of the housing so as to open and close the drain opening of the housing.

16. A washing-water spray apparatus as set forth in claim 13: wherein the spray head has a downward circumferential space adapted to communicate with the spray holes from the lower portion of the circumferential space, and a projection stopper portion formed at a peripheral end of an outer wall of the circumferential space; wherein the rotation driving means is inserted into the circumferential space so as to be rotated together; wherein the opening/closing member has a central throughhole through which to supply washing-water, a pressure working portion extended radially and outwardly from an upper end of the central throughhole so as to move down the opening/closing member by action of washing-water pressure when a washing-water supply passage from the central throughhole to the circumferential space of the spray head is blocked, and an opening/closing portion adapted to open the washing-water supply passage by spacing from the lower end portion of the circumferential inner wall of the spray head when being moved down during washing, and to close the washing-water supply passage by contacting with the lower end portion of the circumferential inner wall of the spray head when being moved up during non-washing; and, wherein a function of the up-down means is performed by said pressure working portion which opens the opening/closing member by the washing-water pressure during washing, and a spring which is installed so as to close the opening/closing member during non-washing.

17. A washing-water spray apparatus as set forth in claim 16: wherein the fastening means comprises a flange installed on a circumferential upper end of a mounting opening of the sink basin, a cylinder portion which is arranged downwardly passing through the mounting opening of the sink basin, and on the periphery of which a male thread is formed, a fixing member which is made up of a projection receiving portion, the projection receiving portion hanging the projection stopper portion of the spray head so as not for the spray head to come off upward, and a fastening nut which installs the spray head on the circumference of the mounting opening of the sink basin by engaging with the male thread of the cylinder portion; and, wherein a lower member is further provided, the lower member having a central cylinder portion to which a washing-water supply line connection is connected and to which the fastening means is fixed at the lower end by screws so as to prevent leakage of washing-water in the lower direction of the opening/closing member.

18. A washing-water spray apparatus as set forth in claim 16, wherein a guide portion for changing a flow direction of washing-water so as to smoothly operate the rotation driving means is upwardly projected from a circumference of the opening/closing portion of the opening/closing member, the guide portion being inserted into the circumferential space of the spray head.

19. A washing-water spray apparatus as set forth in claim 14 or 16: wherein the spray holes are formed with various angles and shapes so as to spray washing-water in the various angles and configurations in the sink basin; and, wherein a space for dispersing a flow direction of washing-water from the rotation driving means is provided between the spray holes of the spray head and the rotation driving means so that washing-water can be sprayed according to various angles and shapes of the spray holes, regardless of an angle of a washing-water flow coming out from the rotation driving means.
